(19) United States
(12) Patent Application Publication
(10) Pub. No.: US 2025/0330835 A1
(43) Pub. Date: Oct. 23, 2025

(54) BASE STATION APPARATUS FOR ESTABLISHING EFFICIENT CONNECTION, TERMINAL APPARATUS, CONTROL METHOD, AND STORAGE MEDIUM

(71) Applicant: KDDI CORPORATION, Tokyo (JP)

(72) Inventors: Takehiro HOSHIKAWA, Tokyo (JP); Toshiaki YAMAMOTO, Tokyo (JP)

(21) Appl. No.: 19/259,405

(22) Filed: Jul. 3, 2025

Related U.S. Application Data
(63) Continuation of application No. PCT/JP2024/000103, filed on Jan. 9, 2024.

(30) Foreign Application Priority Data
Jan. 16, 2023 (JP) 2023-004651

(51) Int. Cl. H04W 16/28; H04W 74/0833

(52) U.S. Cl. CPC H04W 16/28; H04W 74/0833

(57) ABSTRACT

A base station apparatus that forms a plurality of beams notifies a terminal apparatus of setting information with respect to each of the plurality of beams, the setting information indicating a combination of a radio resource to be used by the terminal apparatus in transmission of a random-access preamble and a sequence of a random-access preamble to be transmitted in the radio resource, specifies, in a case where a random-access preamble has been detected in a radio resource corresponding to two or more beams among the plurality of beams, a beam corresponding to a sequence of the detected random-access preamble from among the two or more beams, and establishes connection with the terminal apparatus that has transmitted a detected random-access preamble.

### CROSS-REFERENCE TO RELATED APPLICATION(S)

This application is a continuation of International Patent Application No. PCT/JP2024/000103 filed on Jan. 9, 2024, which claims priority to and the benefit of Japanese Patent Application No. 2023-004651 filed on Jan. 16, 2023, the entire disclosures of which are incorporated herein by reference.

### BACKGROUND OF THE INVENTION

### Field of the Invention

The present invention relates to a technique to accelerate connection from a terminal apparatus to a network.

### Description of the Related Art

The fifth-generation (5G) cellular communication standard of the 3rd Generation Partnership Project (3GPP®) defines the use of beamforming, in which a base station apparatus forms a plurality of beams to increase a gain in relation to a certain direction and performs communication on a per-beam basis, in order to expand areas in a high-frequency band. A gain related to a specific direction increases as a beam width is narrowed; this makes it possible for a terminal apparatus located more distantly from the base station apparatus to communicate with this base station apparatus. Note that if the beam width is narrowed, an area in which communication can be performed is expanded in a direction of a radius centered at the base station apparatus, but on the other hand, an area in which communication can be performed is narrowed in a circumferential direction. For this reason, there is a need to set a large number of beams to provide planar coverage.

A terminal apparatus observes a synchronization signal/physical broadcast channel block (SS/PBCH block, hereinafter referred to as “SSB”) that is transmitted within a certain time period in each beam, and selects a beam suitable for communication (see 3GPP TS38.213, V17.0.0, December, 2021). Then, the terminal apparatus connects to a network and performs communication via the selected beam in a case where it has been notified by a base station apparatus of, for example, the existence of data addressed to itself, or in a case where data to be transmitted has been generated in itself. When connecting to the network, the terminal apparatus transmits a random-access channel (RACH) in a predetermined radio resource (time and frequency resources). On the other hand, if the number of beams increases, a cycle of arrival of the predetermined radio resource in which RACH can be transmitted can be prolonged, and a time period until the terminal apparatus connects to a beam can be prolonged.

### SUMMARY OF THE INVENTION

The present invention provides a technique to shorten a time period until a terminal apparatus connects to a network.

Abase station apparatus according to one aspect of the present invention comprises: a forming unit configured to form a plurality of beams; a notification unit configured to notify a terminal apparatus of setting information with respect to each of the plurality of beams, the setting information indicating a combination of a radio resource to be used by the terminal apparatus in transmission of a random-access preamble and a sequence of a random-access preamble to be transmitted in the radio resource; a specification unit configured to, in a case where a random-access preamble has been detected in a radio resource corresponding to two or more beams among the plurality of beams, specify a beam corresponding to a sequence of the detected random-access preamble from among the two or more beams; and an establishment unit configured to establish connection with the terminal apparatus that has transmitted a detected random-access preamble.

A terminal apparatus according to one aspect of the present invention comprises: a reception unit configured to receive setting information from a base station apparatus in each of a plurality of beams formed by the base station apparatus, the setting information indicating a combination of a radio resource to be used by the terminal apparatus in transmission of a random-access preamble and a sequence of a random-access preamble to be transmitted in the radio resource; a decision unit configured to measure a radio quality with respect to at least a part of the plurality of beams, and decide a beam in which a random-access preamble is to be transmitted; and a transmission unit configured to transmit, in a radio resource corresponding to the decided beam, a random-access preamble that has been generated using a sequence corresponding to the decided beam, wherein the setting information is configured so that, in a case where a radio resource to be used in transmission of a random-access preamble is shared by two or more beams among the plurality of beams, sequences of random-access preambles that respectively correspond to the two or more beams are different from each other.

Further features of the present invention will become apparent from the following description of exemplary embodiments with reference to the attached drawings.

### BRIEF DESCRIPTION OF THE DRAWINGS

FIG. 1 is a diagram showing an exemplary configuration of a wireless communication system;

FIG. 2A is a diagram showing examples of settings of a random-access preamble for each beam;

FIG. 2B is a diagram showing examples of settings of a random-access preamble for each beam;

FIG. 3 is a diagram showing an exemplary hardware configuration of an apparatus;

FIG. 4 is a diagram showing an exemplary functional configuration of a base station apparatus;

FIG. 5 is a diagram showing an exemplary functional configuration of a terminal apparatus; and

FIG. 6 is a diagram showing an example of a flow of processing executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### (Configuration of Wireless Communication System)

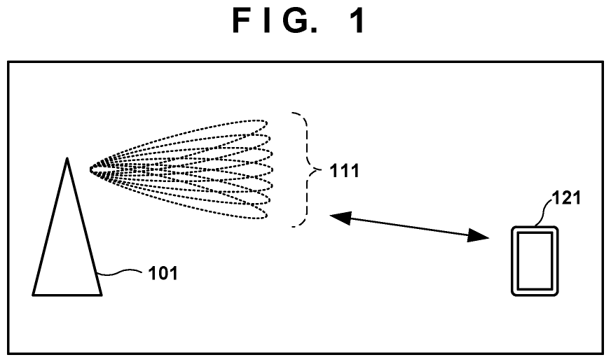

FIG. 1 shows an exemplary configuration of a wireless communication system according to the present embodiment. The present wireless communication system is, for example, a cellular communication system that has been configured in compliance with a cellular communication standard, such as the fifth-generation (5G) standard of the 3rd Generation Partnership Project (3GPP®). The wireless communication system is configured to include a base station apparatus 101 and a terminal apparatus 121. Note that although FIG. 1 shows only one base station apparatus and one terminal apparatus to simplify the description, a large number of base station apparatuses and a large number of terminal apparatuses can naturally exist. The base station apparatus 101 includes, for example, a large number of antennas, and is configured to be capable of forming a plurality of beams 111 in which gains have been improved in different directions, respectively, by adjusting antenna weights. The terminal apparatus 121 can connect to a network (the base station apparatus 101) via one of these plurality of beams 111.

When connecting to the base station apparatus 101, the terminal apparatus 121 receives a synchronization signal/physical broadcast channel (SS/PBCH) block (SSB) that is broadcast by the base station apparatus 101 on a per-beam basis. Note that a maximum of two SSBs can be arranged per time slot. That is to say, in a case where a large number of beams have been formed, SSBs related to a maximum of two beams are transmitted per time slot. The terminal apparatus 121 can observe such SSBs, decode an SSB related to a beam with favorable radio quality, and obtain system information. Then, the terminal apparatus 121 receives this system information and executes a random-access procedure. In the random-access procedure, the terminal apparatus 121 transmits a random-access preamble in a predetermined radio resource (frequency and time resources) specified by the system information. More specifically, the terminal apparatus 121 transmits the random-access preamble so that the random-access preamble is delivered to the base station apparatus 101 in the radio resource set by the base station apparatus 101. The radio resource used in transmission/reception of this random-access preamble is set on a per-beam basis. Here, conventionally, the radio resources corresponding to the plurality of beams are set so that they do not overlap one another. However, when the number of beams is large, even if different radio resources are set in, for example, a frequency direction in order to set the radio resources so that they do not overlap one another, a time cycle of generation of a radio resource corresponding to each beam can be prolonged. As a result, even if the terminal apparatus 121 attempts to connect to a beam with favorable radio quality, a time period until arrival of a radio resource in which a random-access preamble can be transmitted in that beam is prolonged, which is not efficient.

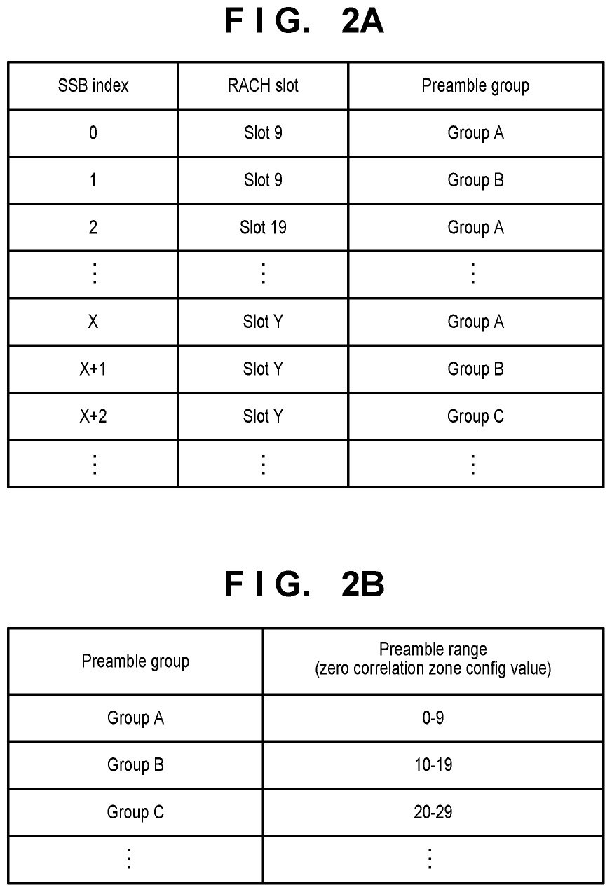

In view of the foregoing issue, the present embodiment provides a method that enables a plurality of beams to use the same radio resource. In the present embodiment, a plurality of beams that use a shared radio resource are respectively assigned different sets of sequences for generating a random-access preamble. FIG. 2A and FIG. 2B show an example of such assignment. In FIG. 2A, an SSB index is an index for identifying a beam. A plurality of beams are uniquely specified by such indexes. A RACH slot indicates a time slot in which a random-access preamble is to be transmitted/received. Note, it is assumed that a frequency resource is shared. FIG. 2A shows an example in which a shared RACH slot is set for beams with SSB indexes of 0 and 1, for example. Also, similarly, a shared RACH slot is set for beams with SSB indexes of X to X+2. In this way, in the present embodiment, a shared radio resource (frequency and time resources) for transmission or reception of a random-access preamble is set for two or more beams among the plurality of beams formed by the base station apparatus 101.

Also, two or more beams for which a shared radio resource for a random-access preamble has been set are respectively assigned different sequence groups for generating a random-access preamble. For example, the beams with SSB indexes of 0 and 1, for which a shared radio resource has been set, are respectively assigned a sequence of group A and a sequence of group B. Here, a range of seeds (zero correlation zone coding (zczc) values) for generating a sequence can be set as a group of a sequence, for example. In the example of FIG. 2B, the beam with an SSB index of 0 is assigned zczc values in the range of 0 to 9, and the beam with an SSB index of 1 is assigned zczc values in the range of 10 to 19. Two sequences generated by different seeds have a small mutual correlation; even if they have been transmitted from separate terminal apparatuses in the same radio resource, they can be separately extracted in the base station apparatus using correlation detection. Therefore, as each group uses seeds that do not overlap with seeds of other groups, it is possible to specify to which group a random-access preamble belongs when the base station apparatus 101 has detected this random-access preamble. For example, in a case where the base station apparatus 101 has detected a random-access preamble that has been generated based on a sequence with a zczc value of 14, it can specify that this random-access preamble belongs to group B. Then, when the base station apparatus 101 has detected this random-access preamble that has used the sequence of group B in the radio resource corresponding to an SSB index of 0 or 1, it can specify that the terminal apparatus 121 has transmitted the random-access preamble toward the beam with an SSB index of 1.

In this case, the base station apparatus 101 can establish connection with the terminal apparatus 121 using the beam with an SSB index of 1. Note that the base station apparatus 101 may decide to establish connection via another beam, for example, in a case where many terminal apparatuses are currently connected to the beam with an SSB index of 1, in a case where the amount of the radio resource that can be used for data communication in that beam is small, or the like. In this case, the base station apparatus 101 may establish connection with the terminal apparatus 121 using, for example, another beam that neighbors this beam. That is to say, although the base station apparatus 101 specifies toward which beam a random-access preamble has been transmitted and establishes connection with the terminal apparatus 121 based on the result of this specification, it may establish connection without using the specified beam.

In the above-described manner, the base station apparatus 101 notifies the terminal apparatus 121 of a combination of a sequence for generation of a random-access preamble and a radio resource with respect to each of the plurality of beams 111. For example, the base station apparatus 101 can provide this notification using system information, such as a Master Information Block (MIB) and a System Information Block Type1 (SIB1). The terminal apparatus 121 can decode system information in each of the plurality of beams formed by the base station apparatus 101, and receive information indicating a combination of a radio resource and a sequence to be used in transmission of a random-access preamble in that beam. Note that the terminal apparatus 121 may not obtain information with respect to, for example, a beam which has insufficient radio quality and for which a radio signal cannot be decoded. Then, the terminal apparatus 121 can measure radio quality with respect to at least a part of the beams, and decide, for example, a beam that has sufficiently favorable (e.g., the best) radio quality as a beam acting as a transmission destination of the random-access preamble. Then, the terminal apparatus 121 can transmit the random-access preamble using a combination of the radio resource and the sequence corresponding to this beam acting as the transmission destination. Note that the terminal apparatus 121 may decide the beam in which the random-access preamble is to be transmitted, and then obtain information related to this beam.

Note that in a case where a combination of a radio resource in which a random-access preamble has been detected and a sequence of this random-access preamble does not correspond to any of combinations included in the information of which the terminal apparatus 121 has been notified by the base station apparatus 101, the base station apparatus 101 does not establish connection with a terminal apparatus that has transmitted this random-access preamble. This is because it is expected that the base station apparatus 101 has detected a random-access preamble addressed to another base station apparatus.

### (Apparatus Configuration)

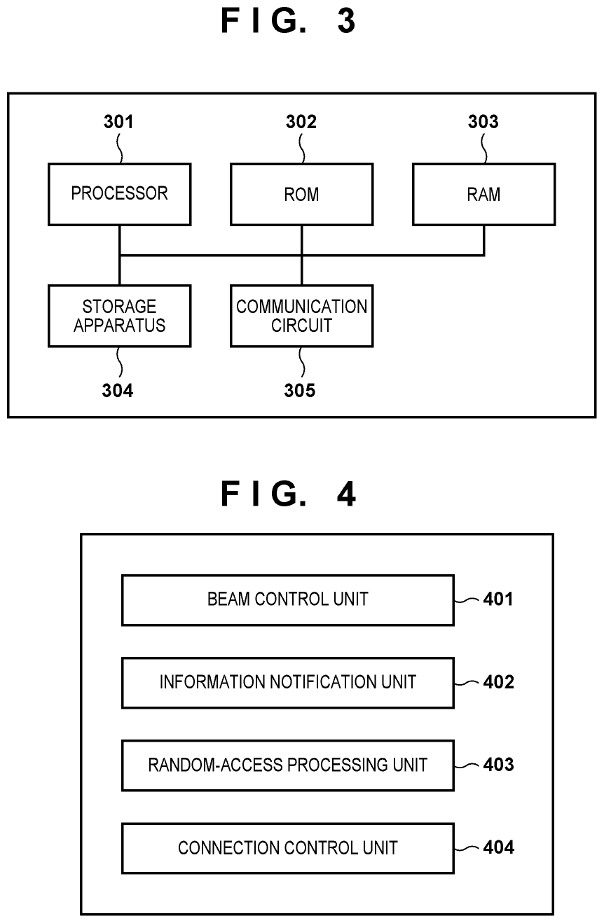

Next, an apparatus configuration will be described. FIG. 3 shows an exemplary hardware configuration of the base station apparatus and the terminal apparatus according to the present embodiment. In an example, the base station apparatus and the terminal apparatus are configured to include a processor 301, a ROM 302, a RAM 303, a storage apparatus 304, and a communication circuit 305. The processor 301 is a computer configured to include one or more processing circuits, such as a general-purpose central processing unit (CPU) and an application-specific integrated circuit (ASIC), and executes processing of the entire apparatus and each process described above by reading out and executing a program stored in the ROM 302 and the storage apparatus 304. The ROM 302 is a read-only memory that stores a program related to processing executed by the base station apparatus and the terminal apparatus, and information of various types of parameters and the like. The RAM 303 is a random-access memory that functions as a working space when the processor 301 executes a program, and that also stores temporary information. The storage apparatus 304 is composed of, for example, an attachable and removable external storage apparatus and the like. The communication circuit 305 is composed of, for example, a circuit for wireless communication based on LTE or 5G. Note that although FIG. 3 shows one communication circuit 305, the base station apparatus and the terminal apparatus can include a plurality of communication circuits. For example, the base station apparatus and the terminal apparatus can include wireless communication circuits that are intended for LTE, 5G, and their successor standards, respectively, and an antenna shared by these circuits. Note that the base station apparatus and the terminal apparatus may include separate antennas suitable for the respective standards. Also, the base station apparatus can further include a wired communication circuit that is used when communicating with nodes of another base station apparatus and a core network. In addition, the terminal apparatus may further include, for example, a communication circuit compliant with wireless communication standards other than a cellular communication standard, such as a wireless local area network (LAN) and Bluetooth®. Note that the base station apparatus and the terminal apparatus may include separate communication circuits 305 in relation to a plurality of usable frequency bandwidths, respectively, or may include a shared communication circuit 305 in relation to at least a part of these frequency bandwidths.

FIG. 4 shows an exemplary functional configuration of the base station apparatus. The base station apparatus includes, for example, a beam control unit 401, an information notification unit 402, a random-access processing unit 403, and a connection control unit 404. Note that in FIG. 4, only the functions that are particularly related to the present embodiment are shown, and the illustration of various types of other functions that can be included in the base station apparatus is omitted. For example, the base station apparatus naturally includes other functions that are generally included in a base station apparatus based on LTE, 5G, or the like. Also, the functional blocks of FIG. 4 are schematically shown; the functional blocks may be realized in an integrated manner, or each functional block may be further segmentalized. Furthermore, each function of FIG. 4 may be realized by, for example, the processor 301 executing a program stored in the ROM 302 or the storage apparatus 304, or may be realized by, for example, a processor that exists inside the communication circuit 305 executing predetermined software. Note that regarding the details of processing executed by each functional unit, the following does not describe the details discussed above, and describes an overview of only general functions thereof.

The beam control unit 401 forms a plurality of beams that can be formed by the base station apparatus. With respect to each of the plurality of beams formed by the beam control unit 401, the information notification unit 402 sets a combination of a radio resource for transmission/reception of a random-access preamble and a sequence for transmission/reception of the random-access preamble. Then, the information notification unit 402 notifies the terminal apparatus of this setting information. Note that in each beam, the information notification unit 402 may provide a notification of setting information that indicates only a combination of a radio resource and a sequence corresponding to this beam, or may provide an additional notification of pieces of setting information related to beams other than this beam. That is to say, in each of the plurality of beams, the information notification unit 402 can provide a notification of pieces of setting information related to two or more (in some cases, all) of these plurality of beams. At this time, the terminal apparatus can specify setting information corresponding to each beam by specifying an SSB index based on an SSB that has arrived from this beam.

The random-access processing unit 403 detects a random-access preamble transmitted from the terminal apparatus. Then, the connection control unit 404 executes a random-access procedure with respect to the terminal apparatus that has transmitted the random-access preamble, and establishes connection with the terminal apparatus. The random-access processing unit 403 specifies to which beam the random-access preamble corresponds based on a combination of a radio resource in which the random-access preamble has been received and a sequence of this random-access preamble. For example, the random-access processing unit 403 performs correlation detection, in a radio resource set by the self-apparatus, with use of the sequence that has been set for a random-access preamble transmitted in this radio resource. Also, in a case where two or more beams correspond to a shared radio resource, the random-access processing unit 403 can determine to which beam the sequence of the random-access preamble detected in this radio resource corresponds. This makes it possible to specify to which beam the random-access preamble has been transmitted.

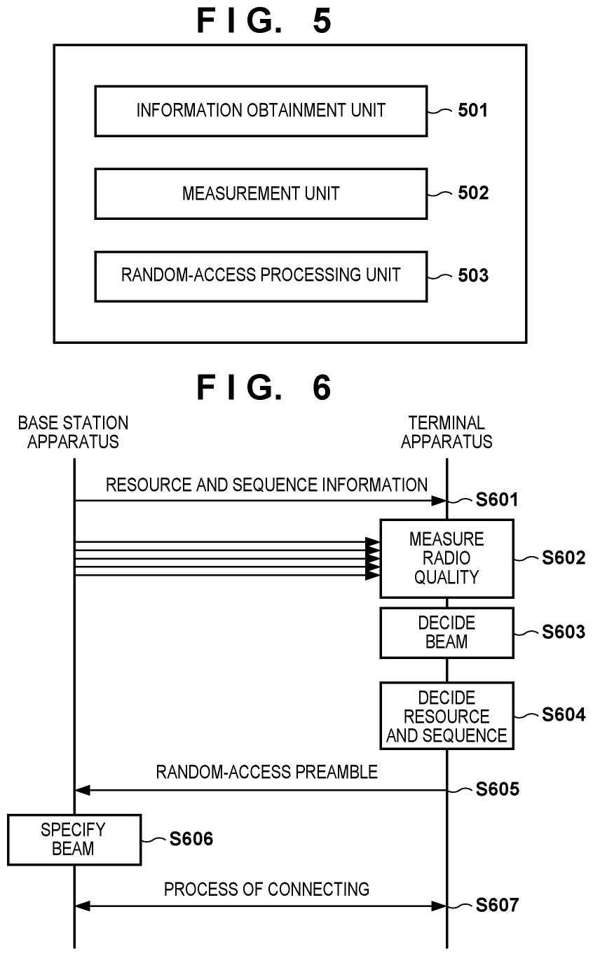

FIG. 5 shows an exemplary functional configuration of the terminal apparatus. The terminal apparatus includes, for example, an information obtainment unit 501, a measurement unit 502, and a random-access processing unit 503. Note that in FIG. 5, only the functions that are particularly related to the present embodiment are shown, and the illustration of various types of other functions that can be included in the terminal apparatus is omitted. For example, the terminal apparatus naturally includes other functions that are generally included in a terminal apparatus based on LTE, 5G, or the like. Also, the functional blocks of FIG. 5 are schematically shown; the functional blocks may be realized in an integrated manner, or each functional block may be further segmentalized. Furthermore, each function of FIG. 5 may be realized by, for example, the processor 301 executing a program stored in the ROM 302 or the storage apparatus 304, or may be realized by, for example, a processor that exists inside the communication circuit 305 executing predetermined software. Note that regarding the details of processing executed by each functional unit, the following does not describe the aforementioned details, and describes an overview of only general functions thereof.

The information obtainment unit 501 receives setting information that has been transmitted from the base station apparatus in the above-described manner via at least one of the plurality of beams formed by this base station apparatus. The measurement unit 502 observes a radio signal related to at least a part of the plurality of beams formed by the base station apparatus, and measures the radio quality thereof. The random-access processing unit 503 selects a beam to which a random-access preamble is to be transmitted based on the result of the measurement performed by the measurement unit 502, transmits the random-access preamble to this beam, and executes a random-access procedure. The random-access processing unit 503 specifies a combination of a radio resource and a sequence corresponding to the selected beam from the setting information obtained by the information obtainment unit 501. Then, using this specified combination of the radio resource and the sequence, the random-access processing unit 503 generates the random-access preamble and transmits the same to the base station apparatus.

### (Flow of Processing)

Next, an overview of an example of a flow of processing that is executed in the wireless communication system according to the present embodiment will be described using FIG. 6.

In the present processing, the base station apparatus sets combinations of a radio resource and a sequence for a random-access preamble that respectively correspond to a plurality of beams formed by itself, and notifies the terminal apparatus of this setting information (step S601). The terminal apparatus holds this setting information. Thereafter, the terminal apparatus observes radio signals, such as SSBs, that have been transmitted respectively in the plurality of beams formed by the base station apparatus, and measures the radio qualities (step S602). Then, based on the result of this measurement, the terminal apparatus decides a beam to which a random-access preamble is to be transmitted (step S603). The terminal apparatus specifies a combination of a radio resource and a sequence corresponding to the decided beam based on the setting information received in step S601 (step S604), and transmits the random-access preamble using this combination of the radio resource and the sequence (step S605). When the base station apparatus has detected a random-access preamble in a radio resource shared by two or more beams, the base station apparatus specifies to which one of the two or more beams the random-access preamble has been transmitted based on the sequence of this random-access preamble (step S606). Then, the base station apparatus establishes connection with the terminal apparatus based on the result of this specification (step S607).

In this way, random-access preambles are transmitted/received in two or more beams using different sequences, respectively; this makes it possible to use the same radio resource for transmission/reception of random-access preambles. As a result, a cycle of arrival of a radio resource for transmission/reception of a random-access preamble can be shortened on a per-beam basis, and connection with the terminal apparatus can be efficiently established. This makes it possible to contribute to Goal 9 of Sustainable Development Goals (SDGs) led by the United Nations, which is to “build resilient infrastructure, promote inclusive and sustainable industrialization, and foster innovation”.

According to the present invention, a time period until the terminal apparatus connects to the network can be shortened.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. Abase station apparatus, comprising:
a forming unit configured to form a plurality of beams;
a notification unit configured to notify a terminal apparatus of setting information with respect to each of the plurality of beams, the setting information indicating a combination of a radio resource to be used by the terminal apparatus in transmission of a random-access preamble and a sequence of a random-access preamble to be transmitted in the radio resource;
a specification unit configured to, in a case where a random-access preamble has been detected in a radio resource corresponding to two or more beams among the plurality of beams, specify a beam corresponding to a sequence of the detected random-access preamble from among the two or more beams; and
an establishment unit configured to establish connection with the terminal apparatus that has transmitted a detected random-access preamble.

2. The base station apparatus according to claim 1, wherein
the establishment unit establishes connection with the terminal apparatus using a specified beam.

3. The base station apparatus according to claim 1, wherein
the establishment unit does not establish connection with the terminal apparatus in a case where a combination of a radio resource in which a random-access preamble from the terminal apparatus has been detected and a sequence of the random-access preamble does not correspond to any of the combinations of the radio resource and the sequence of the random-access preamble that have been notified by the notification unit for the plurality of beams, respectively.

4. A terminal apparatus, comprising:
a reception unit configured to receive setting information from a base station apparatus in each of a plurality of beams formed by the base station apparatus, the setting information indicating a combination of a radio resource to be used by the terminal apparatus in transmission of a random-access preamble and a sequence of a random-access preamble to be transmitted in the radio resource;
a decision unit configured to measure a radio quality with respect to at least a part of the plurality of beams, and decide a beam in which a random-access preamble is to be transmitted; and
a transmission unit configured to transmit, in a radio resource corresponding to the decided beam, a random-access preamble that has been generated using a sequence corresponding to the decided beam,
wherein the setting information is configured so that, in a case where a radio resource to be used in transmission of a random-access preamble is shared by two or more beams among the plurality of beams, sequences of random-access preambles that respectively correspond to the two or more beams are different from each other.

5. A control method executed by a base station apparatus that forms a plurality of beams, the control method comprising:
notifying a terminal apparatus of setting information with respect to each of the plurality of beams, the setting information indicating a combination of a radio resource to be used by the terminal apparatus in transmission of a random-access preamble and a sequence of a random-access preamble to be transmitted in the radio resource;
specifying, in a case where a random-access preamble has been detected in a radio resource corresponding to two or more beams among the plurality of beams, a beam corresponding to a sequence of the detected random-access preamble from among the two or more beams; and
establishing connection with the terminal apparatus that has transmitted a detected random-access preamble.

6. A control method executed by a terminal apparatus, comprising:
receiving setting information from a base station apparatus in each of a plurality of beams formed by the base station apparatus, the setting information indicating a combination of a radio resource to be used by the terminal apparatus in transmission of a random-access preamble and a sequence of a random-access preamble to be transmitted in the radio resource;
measuring a radio quality with respect to at least a part of the plurality of beams, and decide a beam in which a random-access preamble is to be transmitted; and
transmitting, in a radio resource corresponding to the decided beam, a random-access preamble that has been generated using a sequence corresponding to the decided beam,
wherein the setting information is configured so that, in a case where a radio resource to be used in transmission of a random-access preamble is shared by two or more beams among the plurality of beams, sequences of random-access preambles that respectively correspond to the two or more beams are different from each other.

7. A non-transitory computer-readable storage medium that stores a program for causing a computer included in a base station apparatus that forms a plurality of beams to perform operations including:
notifying a terminal apparatus of setting information with respect to each of the plurality of beams, the setting information indicating a combination of a radio resource to be used by the terminal apparatus in transmission of a random-access preamble and a sequence of a random-access preamble to be transmitted in the radio resource;
specifying, in a case where a random-access preamble has been detected in a radio resource corresponding to two or more beams among the plurality of beams, a beam corresponding to a sequence of the detected random-access preamble from among the two or more beams; and
establishing connection with the terminal apparatus that has transmitted a detected random-access preamble.

8. A non-transitory computer-readable storage medium that stores a program for causing a computer included in a terminal apparatus to perform operations including:
receiving setting information from a base station apparatus in each of a plurality of beams formed by the base station apparatus, the setting information indicating a combination of a radio resource to be used by the terminal apparatus in transmission of a random-access preamble and a sequence of a random-access preamble to be transmitted in the radio resource;
measuring a radio quality with respect to at least a part of the plurality of beams, and decide a beam in which a random-access preamble is to be transmitted; and
transmitting, in a radio resource corresponding to the decided beam, a random-access preamble that has been generated using a sequence corresponding to the decided beam,
wherein the setting information is configured so that, in a case where a radio resource to be used in transmission of a random-access preamble is shared by two or more beams among the plurality of beams, sequences of random-access preambles that respectively correspond to the two or more beams are different from each other.
